(19) United States
(12) Patent Application Publication
(10) Pub. No.: US 2021/0061436 A1
(43) Pub. Date: Mar. 4, 2021

(54) FLIGHT TERMINATION SYSTEM FOR AERIAL VEHICLES

(71) Applicant: Loon LLC, Mountain View, CA (US)

(72) Inventors: Kyle Brookes, Redwood City, CA (US); Samuel Truslow, San Francisco, CA (US); Leonard Bouygues, San Francisco, CA (US); John Cromie, Menlo Park, CA (US)

(21) Appl. No.: 16/559,192

(22) Filed: Sep. 3, 2019

(51) Int. Cl. B64B 1/62; B64B 1/48; B64D 1/12; B64D 17/80; B64D 17/62; B64D 17/28

(52) U.S. Cl. CPC B64B 1/62; B64B 1/48; B64D 1/12; B64B 1/06; B64D 17/62; B64D 17/28; B64D 17/80

(57) ABSTRACT

Aspects of the disclosure relate to flight termination systems for aerial vehicles having envelopes. For instance, a flight termination system may include one or more heat sources mounted on the top plate and oriented towards envelope material of the envelope. The one or more heat sources may each include a gas generator configured to generate gas of sufficient temperature to melt the envelope material and vent lift gas from the envelope. The flight termination system may also include a drag device arranged at the top plate which may be being configured to provide stability to the envelope during descent.

### BACKGROUND

Computing devices such as personal computers, laptop computers, tablet computers, cellular phones, and countless types of Internet-capable devices are increasingly prevalent in numerous aspects of modem life. As such, the demand for data connectivity via the Internet, cellular data networks, and other such networks, is growing. However, there are many areas of the world where data connectivity is still unavailable, or if available, is unreliable and/or costly. Accordingly, additional network infrastructure is desirable.

Some systems may provide network access via a balloon network. Because of the various forces experienced by these balloons during deployment and operation, there is a balancing of needs between flexibility and stability of materials. As such, the balloons include a flexible envelope made of material that may be configured in sections or lobes to create a “pumpkin” or lobed envelope. These lobes are supported by a plurality of tendons. During normal operations, the envelope is filled with gas so that it can float above the Earth. At some point, the balloon may need to be brought back to the ground, for example, for retrieval, maintenance or servicing of balloon components.

### BRIEF SUMMARY

One aspect of the disclosure provides an aerial vehicle including: an envelope including a top plate and a flight termination system including one or more heat sources mounted on the top plate and oriented towards envelope material of the envelope. The one or more heat sources each includes a gas generator configured to generate fluid of sufficient temperature to melt the envelope material and vent lift gas from the envelope.

In one example, the one or more heat sources includes a first and second heat source mounted at opposing locations on the top plate such that the first and second heat sources are oriented towards different portions of the envelope material. In another example, the one or more heat sources are arranged to create the one or more openings between tendons of the envelope such that the tendons remain intact when the envelope material is melted. In another example, the system also includes a drag device arranged at the top plate, the drag device being configured to provide stability to the envelope during descent. In this example, the drag device includes a pair of drag elements each including a plurality of supports with material arranged between ones of the plurality of supports. In addition, the one or more heat sources are arranged to create the openings between edges of the drag elements of the pair of drag elements in order to reduce a likelihood of damage to the pair of drag elements when the fluid melts the envelope material. In addition or alternatively, the material arranged between the supports is a same material as the envelope material.

In another example, each gas generator further includes a safety interlock having a pressure switch configured to prevent activation of an initiator of that gas generator below a predetermined altitude. In another example, the system also includes a payload, a separation apparatus including a squib configured to separate the payload from the envelope, and a control system including a pressure sensor. This control system is configured to cause the squib to activate the separation apparatus and separate the payload from the envelope based on feedback from the pressure sensor. In this example, the control system is further configured to receive a pressure for separation and cause the squib to activate the separation apparatus when the feedback indicates that the aerial vehicle has reached the pressure for separation. In addition or alternatively, the system also includes a parachute for the payload, and the control system is further configured to receive a pressure for deployment and cause the parachute for the payload to deploy when the feedback indicates that the payload has reached the pressure for deployment. In this example, the system also includes a parachute for the envelope, and wherein the parachute is configured to deploy upon activation of the separation apparatus and the parachute for the payload is configured to deploy at some point in time after deployment of the parachute for the envelope. In addition, the control system is configured to cause the parachute for the payload to deploy at a lower altitude than the parachute for the envelope is deployed. In addition or alternatively, the parachute for the envelope and the parachute for the payload are configured such that the parachute for the envelope is configured to create a lower amount of drag than the parachute for the payload. In addition or alternatively, the pressure for deployment allows for the payload and the envelope to maintain a minimum separation distance between the payload and the envelope after separation and while both the payload and the envelope are descending.

Another aspect of the disclosure provides an aerial vehicle management system comprising one or more computing devices having one or more processors. The one or more computing devices are configured to determine that flight of an aerial vehicle should be terminated; determine a landing area for the aerial vehicle; determine a ground level of the landing area; based on the determined ground level, determine a pressure for separation that corresponds to an altitude at least a predetermined height above the ground level; determine a pressure for deployment of a parachute for the aerial vehicle based on the determined ground level, wherein the pressure for deployment corresponds to an altitude that is lower than the pressure for separation; and send the pressure for separation and the pressure for deployment to the aerial vehicle in order to cause the aerial vehicle to terminate the flight using the pressure for separation and the pressure for deployment.

In one example, the pressure for deployment corresponds to an altitude that is lower than the pressure for separation. In another example, the predetermined height is at least 10,000 feet above ground level. In another example, the predetermined height is no more than 10,000 feet above ground level. In another example, the system also includes the aerial vehicle.

### BRIEF DESCRIPTION OF THE DRAWINGS

FIG. 1 is an example system including a network of aerial vehicles in accordance with aspects of the disclosure.

FIG. 2 is an example of an aerial vehicle in accordance with aspects of the present disclosure.

FIG. 3 is an example of an aerial vehicle in flight in accordance with aspects of the disclosure.

FIG. 4 is an example cross-sectional view of aspects of a flight termination system and aerial vehicle in accordance with aspects of the disclosure.

FIG. 5 is an example top-down view of aspects of a flight termination system and aerial vehicle in accordance with aspects of the disclosure.

FIG. 6 is an example cross-sectional view of a gas generator in accordance with aspects of the disclosure.

FIG. 7 is an example view of a drag device in accordance with aspects of the disclosure.

FIG. 8 is an example block diagram of a payload including a control system and parachute in accordance with aspects of the disclosure.

FIGS. 9A and 9B depicts an example separation apparatus for separating portions of a connection between a payload and an envelope of an aerial vehicle in accordance with aspects of the disclosure.

FIG. 10 is an example of an aerial vehicle management system in accordance with aspects of the disclosure.

FIG. 11 is an example flow diagram in accordance with aspects of the disclosure.

FIG. 12 is an example flow diagram in accordance with aspects of the disclosure.

FIG. 13 is an example representation of flight termination of an aerial vehicle in accordance with aspects of the disclosure.

### DETAILED DESCRIPTION

### Overview

The present disclosure generally relates to providing a system for terminating a flight of an aerial vehicle such as a high-altitude balloons or airships having a neutrally buoyant envelope. Some such aerial vehicles may be flown at altitudes of 16 to 20 kilometers for hundreds of days. At some point, when these aerial vehicles need to be brought back to the ground, doing so quickly and as predictably as possible is critical. Current techniques may involve creating an opening in the envelope to release lift gas gradually such that the envelope remains largely intact in order to cause the aerial vehicle to slowly descend due to the lift force of the lift gases within the envelope as well as the high drag coefficient of the largely intact envelope. However, as it descends, the aerial vehicle may become a potential hazard for other aerial vehicles such as airplanes. Other techniques may involve creating a very large opening in the envelope, or rather bursting the envelope, in order to rapidly release lift gas. In addition, immediately after venting lift gasses, the envelope may be separated from a payload of the aerial vehicle, and deploying parachutes on the payload and in some instances also the envelope. While this technique may result in a faster descent than the slow descent, now there are two objects that are descending through flight lanes again become potential hazards for other aerial vehicles. To address these issues, the techniques and features described herein may allow for a flight termination and parachute deployment in a manner that allows the aerial vehicle to descend back to Earth while reducing the likelihood of interference with other aerial vehicles and minimizing wind drift (which would otherwise make the prediction of where the aerial vehicle would land.

A flight termination system may include a heat source mounted on an aerial vehicle. For instance, if the aerial vehicle is a balloon, the heat source may be mounted at a top plate of an envelope of the aerial vehicle. The heat source may be such that it is capable of melting an opening in the envelope via fluid such as hot air or other gasses. In fact, the heat source may actually be able to melt through several layers of material, including, for example the envelope as well as an envelope of an internal ballonet. A second heat source may also be used.

In some instances, the heat source may be configured as a gas generator having a safety interlock. The safety interlock may include a pressure switch arranged to short the initiator and prevent its activation above certain pressures to prevent the heat source from activating before necessary.

Once the heat source or heat sources are used to create the openings in an envelope, the envelope may rapidly vent its lift gasses. As such, the envelope may create very little drag on the rest of the aerial vehicle, allowing the aerial vehicle to quickly descend to the ground. However, after lift gasses are vented as described above, because of the greatly decreased drag of the envelope, the envelope may actually overtake the payload and lead to collisions between different parts of the flight vehicle. To avoid this, a drag device may be used to stabilize the orientation of the envelope during descent. The drag device may include a pair of drag elements mounted to the top plate, for instance via bolts or other fasteners. Each drag element may include a plurality of supports with envelope material arranged between them. The drag elements may be arranged such that the openings created by the one or more heat sources are between opposing edges of different drag elements, thereby preventing the hot fluid from the heat sources from damaging the drag device.

The flight termination system may also include features for separating the payload from the envelope as well as parachutes for each of the payload and the envelope. The separation features may be controllable by a control system of the payload. These control systems may include pressure sensors configured to measure atmospheric pressure as well as processors and memory for storing data and instructions. Once a certain altitude is reached, a control system may send a signal to cause the payload and envelope to separate and to activate the parachutes.

In order to cause the aerial vehicle to descend in an expected way, the termination, separation, and parachute deployments may be planned. In some cases, this planning may be done by the control systems of the payload, but in order to reduce unnecessary computation and data storage requirements, this planning may be done remotely by an aerial vehicle management system including one or more server computing devices. The aerial vehicle management system may function as a mission control and perform operations such as determining where flights should be terminated and under what circumstances to meet the desired landing locations specified by operators.

In order to do so, the aerial vehicle management system may determine, based on the last received location information from the aerial vehicle, an area where the aerial vehicle is likely to land if the flight was immediately terminated. In some instances, the aerial vehicle management system may identify a preferred landing area. Once the landing area is determined, the aerial vehicle management system may evaluate the elevation or height of the ground surface of the area. At this point, the aerial vehicle management system may determine a pressure (altitude) corresponding to at least a predetermined height above the ground surface of the area. In addition to determining the pressure for separation, the aerial vehicle management system may also determine a pressure for parachute deployment.

The aerial vehicle management system may then send the pressure for separation, the pressure for deployment, and in some instances, navigation instructions for the location at which to terminate. In response, the control system of the payload may terminate the flight of the aerial vehicle by sending a signal to the heating source or sources to create one or more openings in the envelope. Lift gas within the envelope may then be vented. The control system of the payload may then determine when the pressure sensor of the payload indicates that the aerial vehicle has reached the pressure for separation and cause separation of the payload and the envelope and deployment of the parachutes.

The features described herein may enable termination of a flight of a balloon in a simple and effective way. The use of the heat sources may provide a highly reliable way create large openings to vent lift gasses quickly and thereby effect predictable descent paths and landing areas. In addition, by waiting to separate and deploy the parachutes at certain pressures, this increases the speed at which the aerial vehicle descends through flight path areas and could possibly interfere with other aerial vehicles. At the same time, the speed at which the aerial vehicle descends also minimizes the amount of wind drift (i.e. how much the aerial vehicle drifts in different directions due to wind) which increases the accuracy of predictions of where the aerial vehicle is likely to land. In addition, by deploying the parachutes at different altitudes this further prevents the likelihood of interference between the payload and envelope with one another after separation.

### Example System

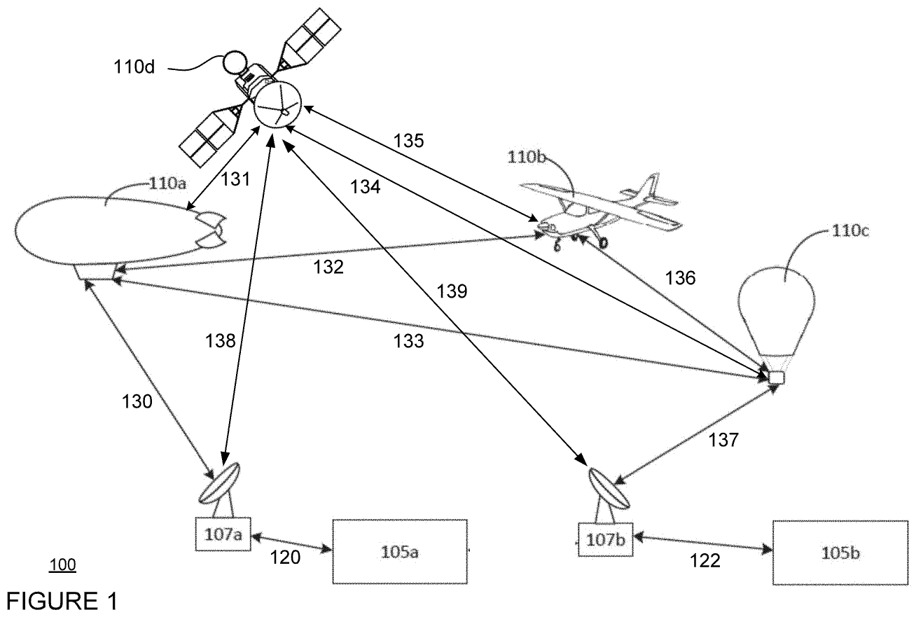

FIG. 1 is a block diagram of an example directional point-to-point network 100. The network 100 is a directional point-to-point computer network consisting of nodes mounted on various land- and air-based devices, some of which may change position with respect to other nodes in the network 100 over time. For example, the network 100 includes nodes associated with each of two land-based datacenters 105a and 105b (generally referred to as datacenters 105), nodes associated with each of two ground stations 107a and 107b (generally referred to as ground stations 107), and nodes associated with each of four airborne high altitude platforms (HAPs) 110a-110d (generally referred to as HAPs 110). As shown, HAP 110a is an aerial vehicle (here depicted as a blimp), HAP 110b is an airplane, HAP 110c is an aerial vehicle (here depicted as a balloon), and HAP 110d is a satellite. In some embodiments, nodes in network 100 may be equipped to perform FSOC, making network 100 an FSOC network. Additionally or alternatively, nodes in network 100 may be equipped to communicate via radio-frequency signals or other communication signal capable of travelling through free space. Arrows shown between a pair of nodes represent possible communication links 120, 122, 130-139 between the nodes. The network 100 as shown in FIG. 1 is illustrative only, and in some implementations the network 100 may include additional or different nodes. For example, in some implementations, the network 100 may include additional HAPs, which may be balloons, blimps, airplanes, unmanned aerial vehicles (UAVs), satellites, or any other form of high altitude platform.

In some implementations, the network 100 may serve as an access network for client devices such as cellular phones, laptop computers, desktop computers, wearable devices, or tablet computers. The network 100 also may be connected to a larger network, such as the Internet, and may be configured to provide a client device with access to resources stored on or provided through the larger computer network. In some implementations, HAPs 110 can include wireless transceivers associated with a cellular or other mobile network, such as eNodeB base stations or other wireless access points, such as WiMAX or UMTS access points. Together, HAPs 110 may form all or part of a wireless access network. HAPs 110 may connect to the datacenters 105, for example, via backbone network links or transit networks operated by third parties. As one example, control commands from the datacenter 105a to HAP 110c (a balloon) may be sent via HAP 110d (a satellite) such that the commands flow from a datacenter to a satellite and subsequently to a balloon. Similarly, information from the HAP 110c may be sent to the datacenter 105a via the HAP 110d such that the information flows from a datacenter to a satellite and subsequently to a balloon. The datacenters 105 may include servers hosting applications that are accessed by remote users as well as systems that monitor or control the components of the network 100. HAPs 110 may provide wireless access for the users, and may route user requests to the datacenters 105 and return responses to the users via the backbone network links. For instance, a user may send and receive information directly with any of the HAPs 110a-110d in order to communicate with the datacenter 105a or 105b. Similarly, the datacenter 105a or 105b may communicate with the devices of users via the HAPs 110a-110d.

### Example Aerial Vehicle

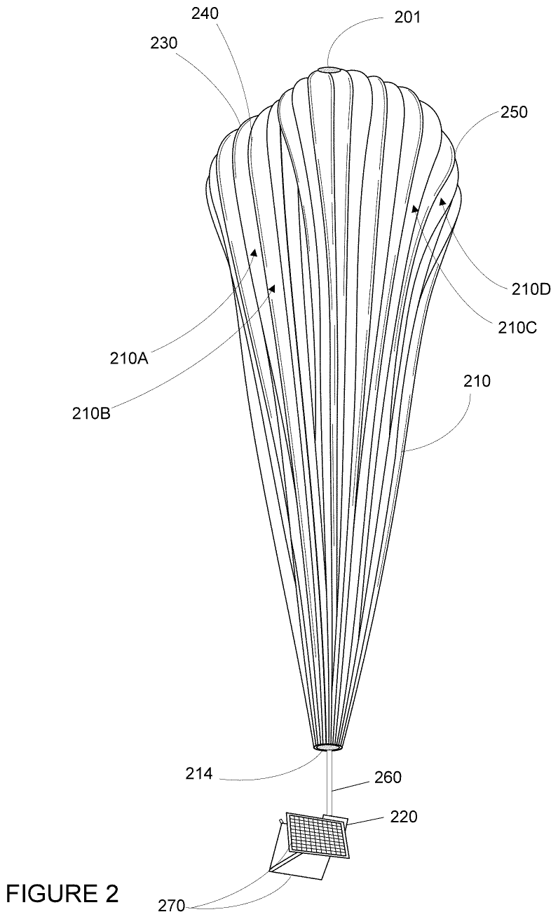

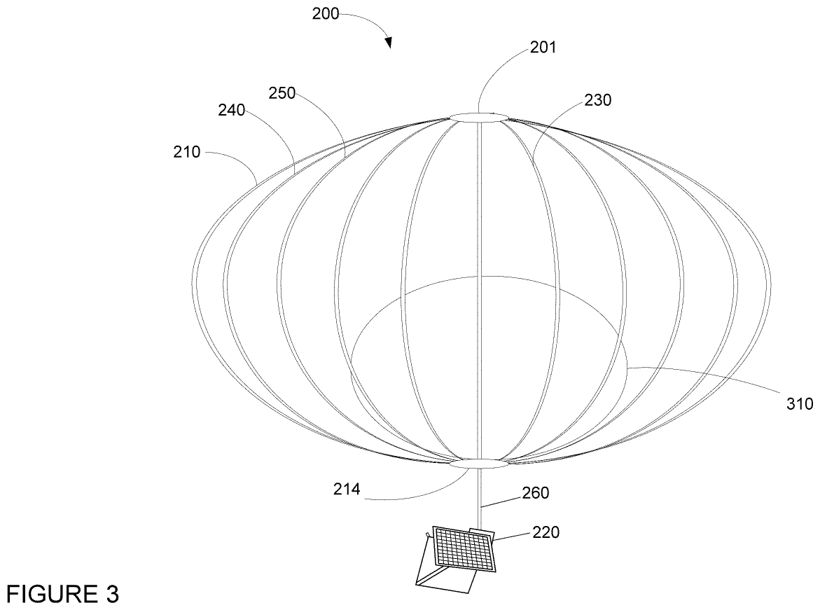

FIGS. 2 and 3 are examples of an aerial vehicle 200 which may correspond to HAP 110c, again, depicted here as a balloon. For ease of understanding, the relative sizes of and distances between aspects of the aerial vehicle 200 and ground surface, etc. are not to scale. As shown, the aerial vehicle 200 includes an envelope 210, a payload 220 and a plurality of tendons 230, 240 and 250 attached to the envelope 210. The envelope 210 may take various forms. In one instance, the envelope 210 may be constructed from materials (i.e. envelope material) such as polyethylene that do not hold much load while the aerial vehicle 200 is floating in the air during flight. Additionally, or alternatively, some or all of envelope 210 may be constructed from a highly flexible latex material or rubber material such as chloroprene. Other materials or combinations thereof may also be employed. Further, the shape and size of the envelope 210 may vary depending upon the particular implementation. Additionally, the envelope 210 may be filled with various gases or mixtures thereof, such as helium, or any other lighter-than-air gas. The envelope 210 is thus arranged to have an associated upward buoyancy force during deployment of the payload 220.

The payload 220 of aerial vehicle 200 may be affixed to the envelope by a connection 260 such as a cable or other rigid structure. The payload 220 may include a computer system (not shown), having one or more processors and on-board data storage. The payload 220 may also include various other types of equipment and systems (not shown) to provide a number of different functions. For example, the payload 220 may include various communication systems such as optical and/or RF, a navigation software module, a positioning system, a lighting system, an altitude control system (configured to change an altitude of the aerial vehicle in order to follow navigation instructions), a plurality of solar panels 270 for generating power, a power supply (such as one or more batteries) to store and supply power to various components of aerial vehicle 200. In this regard, the payload may also include one or more processors and memories as discussed further below.

In view of the goal of making the envelope 210 as lightweight as possible, it may be comprised of a plurality of envelope lobes or gores that have a thin film, such as polyethylene or polyethylene terephthalate, which is lightweight, yet has suitable strength properties for use as an envelope. In this example, envelope 210 is comprised of envelope gores 210A-210D.

Pressurized lift gas within the envelope 210 may cause a force or load to be applied to the aerial vehicle 200. In that regard, the tendons 230, 240, 250 provide strength to the aerial vehicle 200 to carry the load created by the pressurized gas within the envelope 210. In some examples, a cage of tendons (not shown) may be created using multiple tendons that are attached vertically and horizontally. Each tendon may be formed as a fiber load tape that is adhered to a respective envelope gore. Alternately, a tubular sleeve may be adhered to the respective envelopes with the tendon positioned within the tubular sleeve.

Top ends of the tendons 230, 240 and 250 may be coupled together using an apparatus, such as top plate 201 positioned at the apex of envelope 210. A corresponding apparatus, e.g., base plate or bottom plate 214, may be disposed at a base or bottom of the envelope 210. The top plate 201 at the apex may be the same size and shape as and bottom plate 214 at the bottom. Both caps include corresponding components for attaching the tendons 230, 240 and 250 to the envelope 210.

FIG. 3 is an example of the aerial vehicle 200 in flight when the lift gas within the envelope 210 is pressurized. In this example, the shapes and sizes of the envelope 210, connection 260, envelope 310, and payload 220 are exaggerated for clarity and ease of understanding. During flight, these balloons may use changes in altitude to achieve navigational direction changes. In this regard, the envelope 310 may be a ballonet that holds ballast gas (e.g., air) therein, and the envelope 210 may hold lift gas around the ballonet. For example, the altitude control system of the payload 220 may cause air to be pumped into a ballast within the envelope 210 which increases the mass of the aerial vehicle and causes the aerial vehicle to descend. Similarly, the altitude control system may cause air to be released from the ballast (and expelled from the aerial vehicle) in order to reduce the mass of the aerial vehicle and cause the aerial vehicle to ascend. Alternatively, in a reverse ballonet configuration, the envelope 310 may hold lift gas therein and the envelope 210 may hold ballast gas (e.g., air) around the envelope 310, and the envelope 310 may hold the lift gas therein. In either case, the envelope 310 may be attached to one or both of the top plate 201 or the bottom plate 214 (attachment to the bottom plate being depicted in FIG. 3).

### Example Flight Termination System

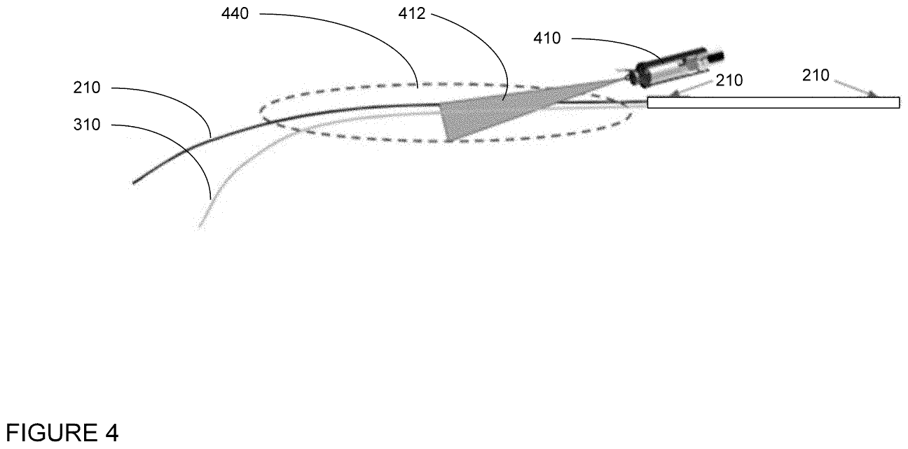

As noted above, in order to termination flight of an aerial vehicle, a flight termination system may be used. FIG. 4 is an example cross-sectional view of aspects of a flight termination system 400 and aerial vehicle 200. The flight termination system may include a heat source mounted on an aerial vehicle. For instance, as shown in FIG. 4, a parachute 430 and a heat source 410 may be mounted at a top plate 201 of the envelope 210 of the aerial vehicle 200. The heat source may be such that it is capable of melting an opening, represented by the area 440, in the envelope 210 using a fluid 412 such as hot air or other gasses. In fact, the heat source 410 may actually be able to melt through several layers of material, including, for example the envelope 210 as well as the ballonet 310.

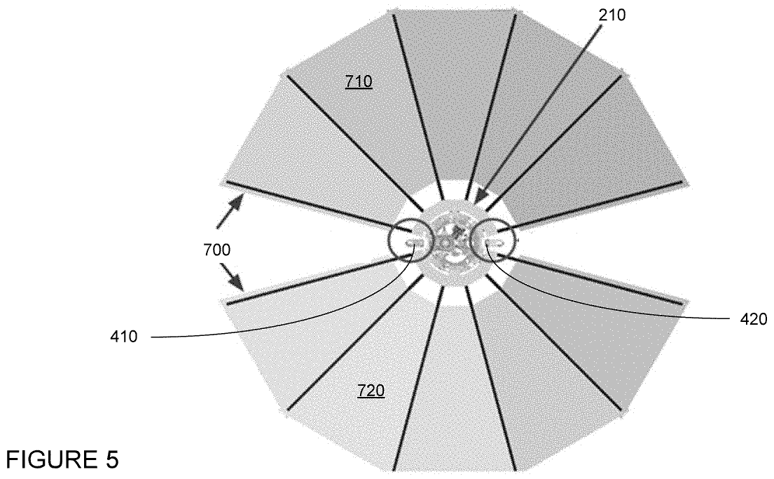

As shown in the top-down view of FIG. 5, the flight termination system 400 may also include a second heat source 420 may also be used. In order to create a second opening in the envelope 210 in a more symmetric manner, the second heat source 420 may be mounted at an opposing position of the top plate 201 with respect to the heat source 410, though other locations, such as directly adjacent to the heat source may also be used. Each heat source 410, 420 may be mounted and oriented such that when in use (i.e. when the aerial vehicle is pressurized and operating in the stratosphere) the fluid from the respective heat source hits the envelope 210 between two tendons creating openings while allowing the tendons to remain intact. This may prevent the envelope 210 from bursting and also the tendons from whipping around and causing damage to other components of the aerial vehicle 200.

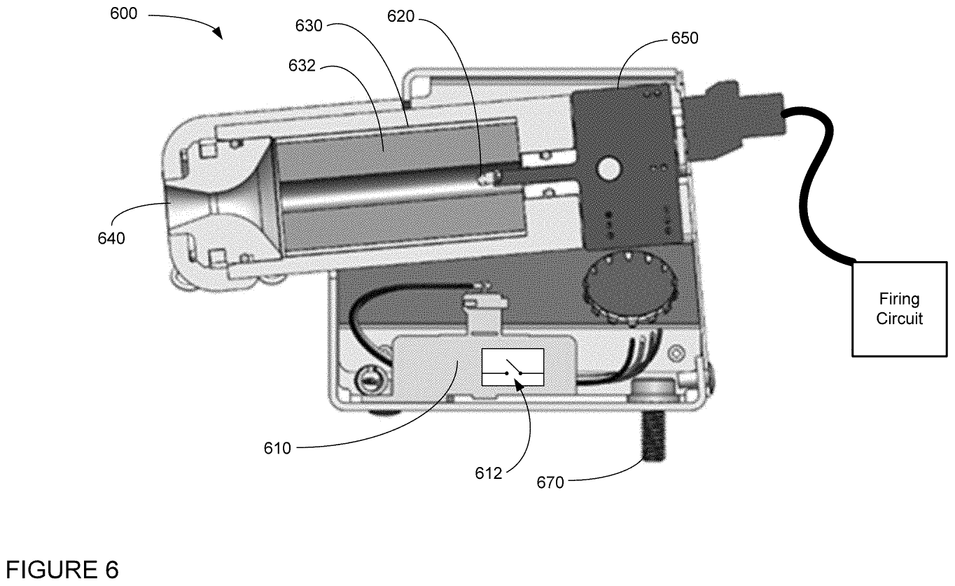

In some instances, the heat sources 410, 420 may be configured as a gas generator having a safety interlock. FIG. 6 is an example cross-sectional view of a gas generator 600 corresponding to either of heat sources 410 or 420. In this example, the gas generator 600 may include a safety interlock 610, a heating element 620, a propellant chamber 630 for housing hot gas generator grain 632, a nozzle 640 (exit), and an initiator 650, and a firing circuit 660. The gas generator may be mounted to the top plate 201, for instance, via one or more bolts 670, screws or other fasteners.

The heating element 620 of the initiator 650 may be configured a nichrome wire coil design that permits bulk heating—of the initiator combustion material. The heating element 620 may be in a helical configuration and may be formed, for example, from 30 awg wire (such as 0.010″ nichrome wire) providing 0.45-0.55 ohms of resistance. Because the hot gas generator (grain and initiator) mixture has a relatively high auto-ignition temperature, and because generating a flame to initiate the grain is not trivial in the stratosphere, the gas generator 600 may be a practical approach to providing hot fluid to melt the envelope 210.

In some examples, the same propellent for both grain and initiator may be used, and the heating element 620 may be dipped in a denatured alcohol thinner in order to improve the flow characteristics of the mix. In this regard, that when a nichrome wire helix is dipped, the material sufficiently “wets out” the wire and forms the desired geometry.

The firing circuit 660 may be mounted to the top plate 201 or at another location on the aerial vehicle 200. In addition, the firing circuit 660 may include a battery or other power supply that can power circuitry for the gas generator 600. The circuitry may include a receiver configured to receive a signal from the control system 810 (discussed further below) in order to cause the heating element 620 of the initiator 650 to ignite the grain 632 and force fluid (here hot gas) out of the nozzle 640. As an example, this configuration of the gas generator may provide a 400 Celsius ignition temperature when operating at −70 Celsius within 3 seconds and the firing circuit 660 is consuming 30 Joules of energy.

The safety interlock 610 may include a pressure switch 612 arranged to short the initiator and prevent its activation above pressures corresponding to approximately 25,000 feet. This may prevent the gas generator 600 (or rather, heat sources 410, 420) from activating and expelling hot fluid before necessary. The safety interlock 610 may also permit easier shipment and safer handling of the gas generator 600 and/or aerial vehicle 200.

Once the heat source or heat sources 410, 420 are used to create the openings in an envelope 210, the envelope may rapidly vent its lift gasses. As such, the envelope 210 may create very little drag on the rest of the aerial vehicle, allowing the aerial vehicle to quickly descend to the ground. As noted above, this may reduce the likelihood of interference with other aerial vehicles, thereby reducing the risk of mid-air collisions and the burden on air traffic controllers.

However, after lift gasses are vented as described above, because of the greatly decreased drag of the envelope 210, the envelope may actually overtake the payload and lead to collisions between different parts of the flight vehicle. To avoid this, a drag device may be used to stabilize the orientation of the envelope during descent and even in conditions where the envelope bursts or has significant leaks.

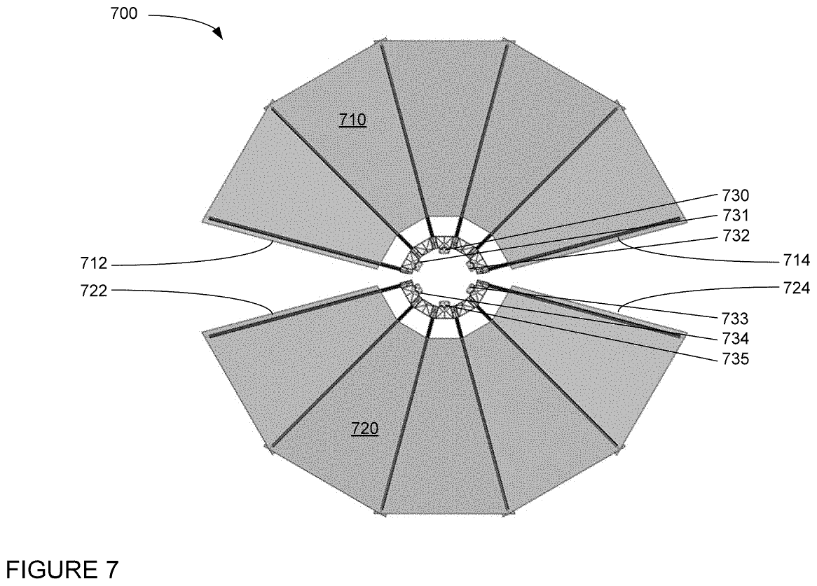

Turning to FIG. 7, a drag device 700 may include a pair of drag elements 710, 720 mounted via mounting brackets 730-735 to the top plate, for instance using bolts, screws or other fasteners. Each drag element 710, 720 may be shaped as a wing or flap including a plurality of supports with envelope material arranged between them. The drag elements 710, 720 may be arranged such that the openings created by the one or more heat sources are between opposing edges 712 and 722 of drag elements 710, 720, respectively, and between opposing edges 714 and 724 of drag elements 710, 720, respectively, thereby preventing the hot fluid from the heat sources 410, 420 from damaging the drag device 700. As the envelope 210 descends, air hitting the drag elements 710, 720 from below may actually create up to 100 newtons of tension on the envelope 210. This tension may help to maintain the orientation of the envelope 210 (i.e. keep the envelope vertical), and thereby also the payload 220, relative to the ground. This may also prevent the envelope 210 from creating a hazard to other aspects of the aerial vehicle 200 during descent.

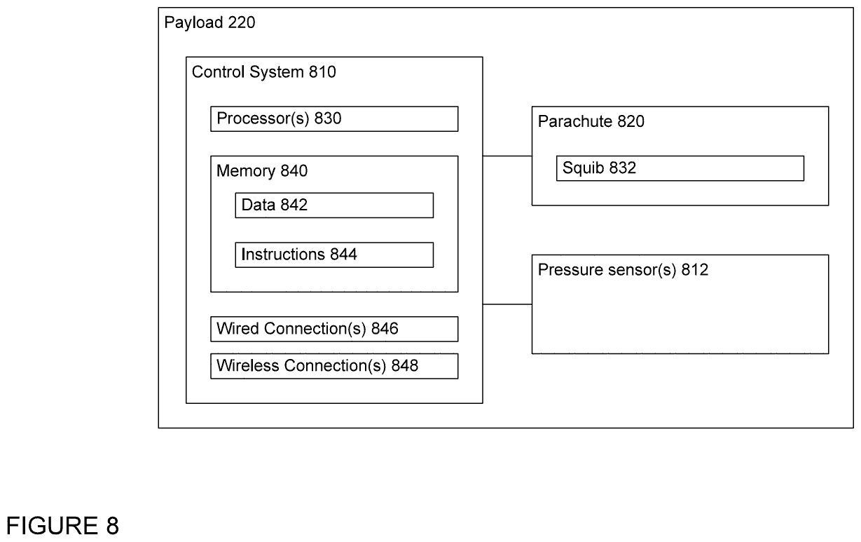

The flight termination system 400 may also include features for separating the payload 220 from the envelope 210 as well as parachutes for each of the payload and the envelope. The separation features may be controllable by a control system of the payload. FIG. 8 is an example block diagram of the payload 220 including a control system 810 and parachute 820. The control system may also include one or more pressure sensors 812 configured to measure atmospheric pressure as well as processors 830 and memory 840 for storing data 842 and instructions 844.

The memory 840 stores information accessible by the one or more processors 830, including instructions 844 and data 842 that may be executed or otherwise used by the processors 830. The memory 840 may be of any type capable of storing information accessible by the one or more processors, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 844 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 842 may be retrieved, stored or modified by the one or more processors 830 in accordance with the instructions 844. For instance, although the claimed subject matter is not limited by any particular data structure, the data may be stored in computing device registers, in a relational database as a table having a plurality of different fields and records, XML documents or flat files. The data may also be formatted in any computing device-readable format. For instance, data may store information about the expected location of the sun relative to the earth at any given point in time as well as information about the location of network targets.

The one or more processors 830 may be any conventional processors, such as commercially available CPUs or GPUs. Alternatively, the one or more processors may be a dedicated device such as an ASIC or other hardware-based processor. Although FIG. 4 functionally illustrates the processor 830, memory 840, and other elements of the control system 810 as being within the same block, it will be understood that the processors or memory may actually include multiple processors or memories that may or may not be stored within the same physical housing. For example, memory may be a hard drive or other storage media located in a housing different from that of the control system 810. Accordingly, references to a processor or computing device will be understood to include references to a collection of processors or computing devices or memories that may or may not operate in parallel.

The control system 810 may also include one or more wired connections 846 and wireless connections 848 (such as transmitters/receivers) to facilitate communication with other devices, such as the squib 832 and squib 966 (discussed further below), server computing devices 1010, and other devices of the aerial vehicle 200 and/or system 100.

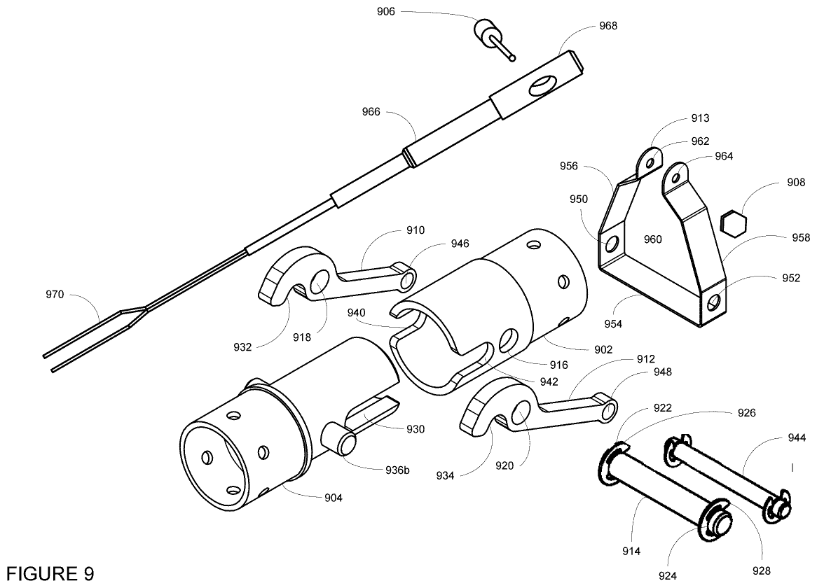

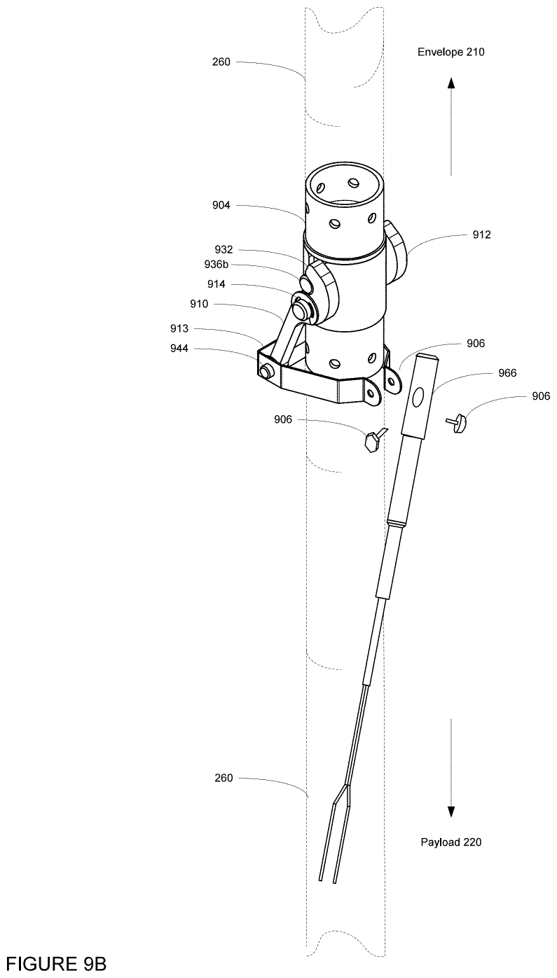

Once a certain altitude is reached, the control system 810 may send a signal to activate a squib that separates the envelope from the payload by releasing a locking or other mechanism. For example, FIGS. 9A-9B depicts an example separation apparatus 900 for separating portions of the connection 260 in order to separate the payload 220 from the envelope 210. FIG. 9A is an example of a separation apparatus 900 shown in an exploded view, and FIG. 9B is a perspective view of the separation apparatus 900. Prior to separation of the connection between the envelope and payload, the separation apparatus may include two shafts 902, 904 which connect with one another and are locked together using a pin 906 and nut 908. For instance, a second shaft 904 may be slid at least partially within a first shaft 902. As an example, the first and second shafts maybe arranged at ends of a pair of 1.5 inch aluminum tubes.

The first and second shafts may be configured to connect with the envelope and the payload, respectively. For example, the first shaft 902 may be configured to attach to a first portion of the connection 260 (shown in dashed line in FIG. 9B) via bolts, rivets, or other connectors. The first portion of the connection 260 may be a tube connected to the payload 220. The second shaft 904 may be configured to attach to a second portion of the connection 260 (shown in dashed line in FIG. 9B) via bolts, rivets, or other connectors. The second portion of the connection 260 may be a tube connected to the envelope 210, for example, at the bottom cap 202 of the balloon. A pair of arms 910, 912 attached to a bracket 913 may be used to secure the first and second shafts 902, 904 to one another, and thereby the envelope and payload, to one another.

The pair of arms 910, 912 may each connect to the first shaft 902 via a first bolt 914. The first bolt 914 may be arranged through a pair of first holes 916 (only a single hole of the pair of first holes being visible in FIG. 9) in the first shaft and a pair of corresponding first holes 918, 920, one in each of the arms 910, 912. The first bolt 914 may be secured to the first shaft 902 using nuts or external retaining rings 922, 924 arranged in corresponding groove 926, 928 on the first bolt. Prior to separation, when the first and second shafts 902, 904 are connected, the first bolt may sit within two first slots 930 (only a single slot of the two first slots being visible in FIG. 9) at opposite sides of the second shaft 904.

Adjacent to the respective corresponding first hole 918, 920 in each arm 910, 912 may be a curved finger 932, 934 which is configured to rest around at least a part of one of two projections 936a (shown in FIG. 7F), 936b on the second shaft 904. Prior to separation, when the first and second shafts 902, 904 are connected, the projections 936a, 936b may sit within two second slots 940, 942 at opposite sides of the first shaft 902.

Each of the arms 910, 912 may be connected to the bracket 913 via a second bolt 944. For example, at an opposite end of each arm 910, 912 from the fingers 932, 934 may be a corresponding second hole 946, 948. The second holes 946, 948 may be aligned with two first bracket holes 950, 952 in the bracket 913. The second bolt 944 may thus be arranged through the corresponding second holes 946, 948 and the first bracket holes 950, 952. The second bolt may be secured to the bracket using nuts or external retaining rings arranged in corresponding grooves on the second bolt.

The bracket 913 may include a base 954, two bracket arm structures 956, 958, and an opening 960 there between. The two first bracket holes 950, 952 may be arranged through the arm structures 956, 958 proximate to the base 954. At the opposite end of the two bracket arm structures 956, 958 may be two second bracket holes 962, 964. Prior to separation, the bracket arm structures 956, 958 may be arranged around the first shaft 902 such that the first shaft sits within the opening 960. The pin 906, placed through the two second bracket holes 950, 952, holds the bracket arm structures 956, 958 and bracket 913 in place around the first shaft 902.

A squib 966 may be arranged around the pin 906 at a blade end 968 of the squib. The blade end 968 houses a blade (not shown). Opposite of the blade end is a receiver end 970 configured to receive an electrical signal to activate the blade of the blade end 968. The arms 910, 912 and angle of contact with the pin 906 cause the squib 966 to see only a small fraction of the total load on the system. For instance, in a tensile load case of 800 pounds, the pin only has to hold 40-50 pounds, a significant decrease.

The separation apparatus 900 may be formed from various materials. As an example, the bracket may be formed from stainless steel such as Type 301 stainless steel. The first and second shafts 902, 904 may be formed from aluminum or an aluminum alloy such as 6061-t6. The arms 910, 912 may also be formed from aluminum or an aluminum alloy such as 7075-t6. The squib 966 may be any such device including a blade capable of cutting the pin 906 at high altitudes, such as squibs used for skydiving which include metal blades.

As previously discussed, the following operations do not have to be performed in the precise order described below. Rather, as mentioned above, various operations can be handled in a different order or simultaneously, and operations may be added or omitted. The separation apparatus 900 may be activated by an electrical signal to the receiver end 970 of squib 966, for instance, sent by the control system 810. The electrical signal may trigger the squib to release the blade from its housing at the blade end 968 of the squib 966. The blade then cuts through the pin 906. One the pin is cut into two pieces, and the squib 966 may fall away from the bracket 913.

Cutting of the pin 906 causes the bracket arms to separate, releasing the first shaft 902 from the bracket 913. The weight of the payload and the angle of the contact area of the arms 910, 912, causes the arms 910, 912 to pivot around first bolt 914. The curved fingers 932, 934 of the arms 910, 912 release the projections 936a, 936b. At the same time, the pivoting of the arms 910, 912 pulls the base 954 of the bracket 913 away from the first shaft 902. Because there is nothing holding the first and second shafts together, they fall away from one another, causing the payload 220 to fall away from the envelope 210. The arms 910, 912 and bracket 913 may still remain attached to the first shaft 902 via the first and second bolts 914, 944 after separation.

Additional aspects of the separation apparatus are described in U.S. Pat. No. 10,059,420, the entire disclosure of which is incorporated herein by reference.

At the same time, the separation action may cause parachute 430 to be automatically deployed via aerodynamic forces such as dynamic pressure or drag. In some instances, the parachute 430 may be a drogue parachute used to stabilize the envelope 210. In some examples, parachute 430 may include a smaller drogue parachute which deploys a larger main canopy.

For instance, once a certain altitude is reached as determined from feedback from the one or more pressure sensors 812, the control system 810 may send a signal to activate a squib 832 that releases a release pin of the parachute thereby causing the parachute 820 to deploy. Alternatively, a non-release pin activation method may be used. In some examples, the parachute 820 may also be a drogue parachute used to stabilize the payload 220 while the parachute separates from the envelope enabling a known separation distance to be controlled between envelope 210 and payload 220 in order to enable a reliable deployment of the parachute 820 at a distance which reduces the risk of the envelope 210 and payload 220 from colliding after respective parachutes 430, 830 are deployed.

In order to cause the aerial vehicle 200 to descend in an expected way, the termination, separation, and parachute deployments may be planned. In some cases, this planning may be done by the control system 810 of the payload, but in order to reduce unnecessary computation and data storage requirements, this planning may be done remotely by an aerial vehicle management system including one or more server computing devices. The aerial vehicle management system may function as a mission control and perform operations such as determining where flights should be terminated and under what circumstances to meet the desired landing locations specified by operators.

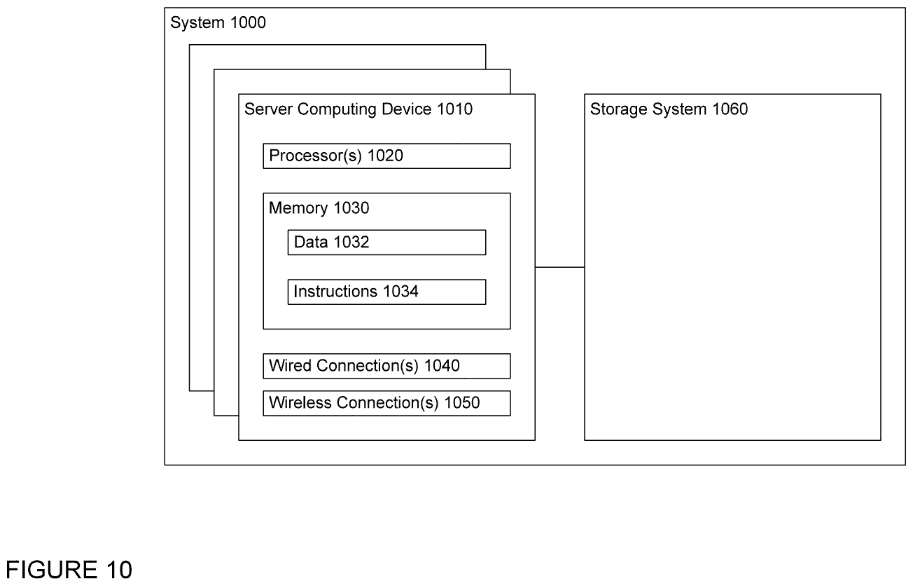

For example, FIG. 10 is an example of an aerial vehicle management system 1000 which may be, for instance, incorporated into datacenters 105 or another datacenter that can communicate with datacenters 105 in order to send/receive information with the HAPs as described above. As shown, the aerial vehicle management system 1000 includes one or more server computing devices 1010 and a storage system 1060. For instance, each of the datacenters may include the storage system 1060 as well as the server computing devices 1010. In this regard, the server computing devices may function as a load balanced server farm in order to exchange information with different nodes of various networks (including network 100) for the purpose of receiving, processing and transmitting the data to and from other computing devices. As such, each of the one or more server computing devices 1010 may include one or more processors 1020, memory 1030 (including data 1032 and instructions 1034) and other components typically present in general purpose computing devices. The processors 1020 and memory 1030 may be configured similarly to processors 830 and memory 840 described above.

The server computing devices 1010 may also include one or more wired connections 1040 and wireless connections 1050 (such as transmitters/receivers) to facilitate communication with other devices, such as the storage system 1060 and control system 810 of aerial vehicle and other devices of the network 100.

As with memory 840, 1030, the storage system 1060 can be of any type of computer storage capable of storing information accessible by the server computing devices 1010, such as a hard-drive, memory card, ROM, RAM, DVD, CD-ROM, write-capable, and read-only memories. In addition, storage system 460 may include a distributed storage system where data is stored on a plurality of different storage devices which may be physically located at the same or different geographic locations. Storage system 1060 may be connected to the server computing devices 1010 directly (i.e. as part of server computing devices 1010 and/or via wired connections 1040) and/or via a network (i.e. via wired connections 1040 and/or wireless connections 1050). This network may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Storage system 1060 and/or memory 1030 may store various types of information as described in more detail below. This information may be retrieved or otherwise accessed by one or more server computing devices, such as the server computing devices 1010, in order to perform some or all of the features described herein. For instance, the storage system 460 and/or memory 1030 may store elevation maps identifying the elevation of ground level at different points on the Earth's surface. The storage system 1060 may also store information identifying conditions when an aerial vehicle's flight should be terminated. An aerial vehicle's flight may be terminated for any number of reasons, including, for instance, the aerial vehicle nearing the end of its expected lifetime, the aerial vehicle experiencing or expected to be experiencing a catastrophic failure (such as loss of power), in order to enable data collection from the aerial vehicle, the aerial vehicle requires maintenance, the aerial vehicle is no longer needed, the server computing devices have not received communications from the aerial vehicle (i.e. a communications link has been lost), or simply when an operator has provided instructions to terminate the flight of the aerial vehicle.

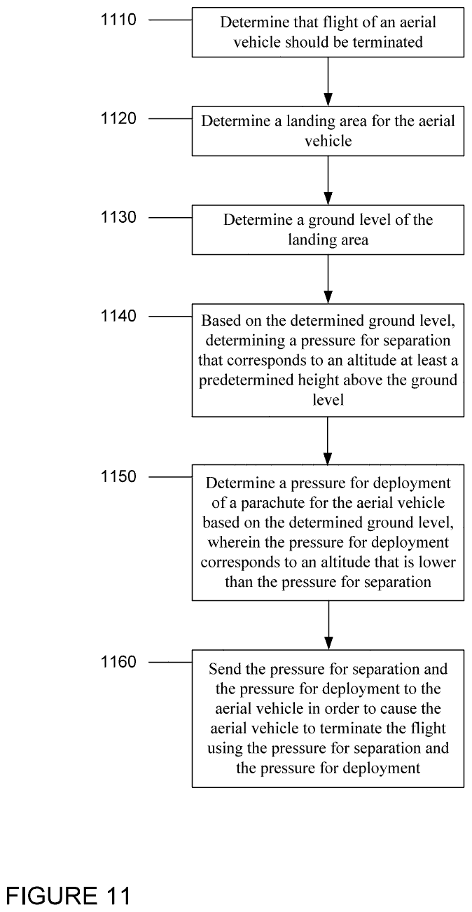

FIG. 11 is an example flow diagram that may be performed, for example, by the one or more processors 1020 of the one or more server computing devices 1010. At block 1110, that a flight of an aerial vehicle should be terminated is determined. For example, the one or more server computing devices 1010 may receive status updates from the control system 810 of the aerial vehicle 200. Using this information and/or user input from an operator, the aerial vehicle control system 1010 may determine that one or more conditions identified in the storage system 1060 are met for the aerial vehicle 200. In response, the aerial vehicle control system 1010 may determine the circumstances for the termination of the flight of an aerial vehicle.

At block 1120, a landing area for the aerial vehicle may be determined. In order to do so, the one or more processors 1020 of the aerial vehicle management system 1000 may determine, based on the last received location information from the aerial vehicle, an area where the aerial vehicle is likely to land if the flight was immediately terminated. This may involve running simulations based on the characteristics of the aerial vehicle and current wind conditions at different altitudes proximate to a location of the last received location information. In some instances, the aerial vehicle management system may identify a preferred landing area, for instance which may be selected by an operator, and may run simulations to determine a location at which the aerial vehicle should be located in order to reach the preferred landing area given the characteristics of the aerial vehicle and current or expected wind conditions. In such instances, the aerial vehicle management system may generate navigation instructions for the aerial vehicle to reach the determined location.

At block 1130, a ground level of the landing area may be determined. Once the landing area is determined, the aerial vehicle management system may evaluate the elevation or height of the ground surface of the area (relative to sea level) or the ground level, for instance using the aforementioned elevation maps.

At block 1140, based on the determined ground level, a pressure for separation that corresponds to an altitude at least a predetermined height above the ground level may be determined. For instance, the aerial vehicle management system may determine a pressure (altitude) corresponding to at least a predetermined height above the ground surface of the area. As an example, this predetermined height may be 10,000 feet or more or less above ground level. This pressure may correspond to a location where the control system of the payload 220 of the aerial vehicle 200 should send a signal to separate the envelope 210 from the payload 220.

At block 1150, a pressure for deployment of a parachute for the aerial vehicle is determined based on the determined ground level. In this example, the pressure for deployment corresponds to an altitude that is lower than the pressure for separation. In addition to determining the pressure for separation, the aerial vehicle management system 1000 may also determine a pressure for parachute deployment. In order to maintain a minimum separation distance or rather, a minimum vertical separation distance between the payload 220 and the envelope 210, the parachute 430 for the envelope may be automatically deployed during the separation as described above, and at some time later, the parachute 820 for the payload 220 may be deployed. As an example, the parachute 820 for the payload 220 may be deployed at an altitude corresponding to 8,000 feet above the ground level of the area (or 2,000 feet below the pressure for separation). In this regard, the minimum separation distance may be approximately 2,000 feet or more or less.

In addition, the parachutes 430, 820 can be different sizes so that there are similar weights and drag factors for each of the payload 220 and the envelope 210. In this regard, the payload 220 and the envelope 210 may descend at or nearly at the same rate with some vertical separation, and thereby preventing both features from being in the same plane at the same time and potentially interfering with one another during descent. In other words, because the payload 220 may weigh more than the envelope 210, the parachute 430 for the envelope 210 may cause a lower amount of drag on the envelope 210 than an amount of drag caused by the parachute 820 for the payload 220 on the payload in order to cause the payload 220 and the envelope 210 to descent at or nearly at the same rate.

At block 1160, the pressure for separation and the pressure for deployment may be sent to the aerial vehicle in order to cause the aerial vehicle to terminate the flight using the pressure for separation and the pressure for deployment. The aerial vehicle management system 1010 may then send the pressure for separation, the pressure for deployment for the parachute 820, and in some instances, the navigation instructions for the location at which to terminate.

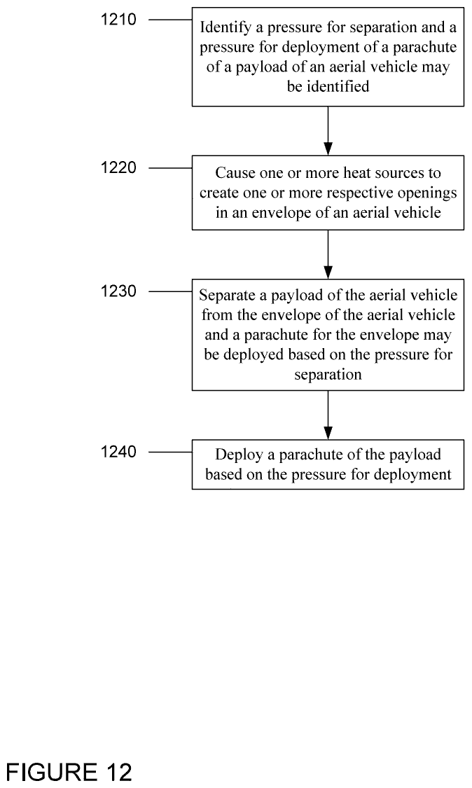

FIG. 12 is an example flow diagram that may be performed, for example, by the features of an aerial vehicle. At block 1210, a pressure for separation and a pressure for deployment of a parachute of a payload of an aerial vehicle may be identified. For example, the pressure for separation and pressure for deployment may be received from the server computing devices 1010 and/or may be determined by the control system 810. In some instances, the navigation instructions for the location at which to terminate may also be received or determined. In such examples, the control system 810 may use the navigation instructions to control the aerial vehicle to reach the location at which to terminate.

At block 1220, cause one or more heat sources to create one or more respective openings in an envelope of an aerial vehicle. Assuming the aerial vehicle is at or has reached the termination location, the control system 810 of the payload 220 may terminate the flight of the aerial vehicle 200 by sending a signal to the heat source or heat sources 410, 420 in order to create one or more openings in the envelope 210. Lift gas within the envelope 210 may then be vented.

At block 1230, a payload of the aerial vehicle is separated from the envelope of the aerial vehicle and a parachute for the envelope may be deployed based on the pressure for separation. For instance, the control system 810 of the payload 220 may then determine when feedback from the one or more pressure sensors 812 indicates that the aerial vehicle 220 has reached the pressure for separation. At that point, the control signal of the payload may send a signal to cause separation of the payload 220 and the envelope 210. The physical separation of the payload 220 from the envelope 210 may then deploy the parachute 430 of the envelope 210. In some instances, the separation may cause both the envelope and payload parachutes to deploy automatically in order to enable highly reliable deployment of both envelope and payload parachutes 430, 820.

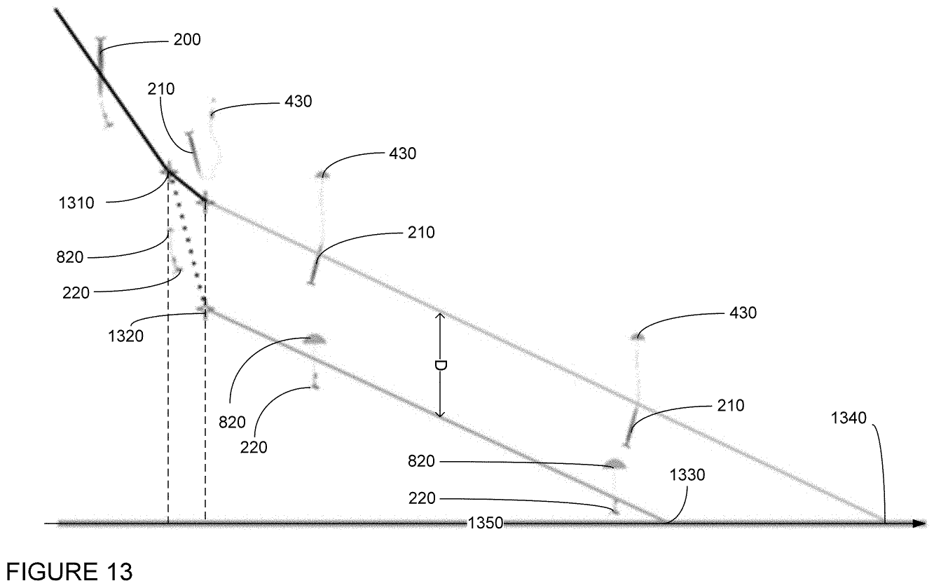

Alternatively, in order to maintain a desired separation distance during descent of a payload and an envelope of the aerial vehicle, as shown in block 1240, a parachute of the payload is deployed based on the pressure for deployment. For instance, the control system 810 of the payload 220 may determine when one or more pressure sensors 812 of the payload 220 indicates that the aerial vehicle 200 has reached the pressure for deployment of the parachute 820 of the payload and deploy the parachute. This desired separation is depicted in FIG. 13 as flight of the aerial vehicle 200 is terminated the payload 220 and envelope 210 descend to ground level over time. In this example, time increases in the direction of arrow 1350. The point 1310 represents at point in time at which the aerial vehicle 200 reaches the pressure for separation and deployment of the parachute 430, and point 1320 represents a point in time at which the payload 220 reaches the pressure for deployment of the parachute 820. In addition, point 1330 represents a point in time at which the payload 220 reaches ground level and lands, and point 1340 represents a point in time at which the envelope 210 reaches ground level and lands. In addition, the distance D represents a minimum separation distance between the payload 220 and the envelope 210 until the payload 220 reaches ground level and lands, which may be earlier in time than the envelope 210 reaches ground level and lands.

In some instances, the parachutes 430, 820 may also include respective parachute release mechanisms to prevent dragging caused by wind on the ground after the payload or envelope have landed. This may be by squib-controlled ring release mechanisms and fired either manually or automatically.

The features described herein may enable termination of a flight of an aerial vehicle having an envelope in a simple and effective way. The use of the heat sources may provide a highly reliable way create large openings to vent lift gasses quickly and thereby effect predictable descent paths and landing areas. In addition, by waiting to separate and deploy the parachutes 430, 820 at certain pressures or rather, altitudes, this increases the speed at which the aerial vehicle 200 descends through flight path areas and could possibly interfere with other aerial vehicles. At the same time, the speed at which the aerial vehicle 200 descends also minimizes the amount of wind drift (i.e. how much the aerial vehicle drifts in different directions due to wind) which increases the accuracy of predictions of where the aerial vehicle is likely to land. In addition, by deploying the parachutes 430, 820 at different altitudes this further prevents the likelihood of interference between the payload 220 and envelope 210 with one another after separation.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. An aerial vehicle including:
an envelope including a top plate; and
a flight termination system including one or more heat sources mounted on the top plate and oriented towards envelope material of the envelope, the one or more heat sources each including a gas generator configured to generate fluid of sufficient temperature to melt the envelope material and vent lift gas from the envelope.

2. The aerial vehicle of claim 1, wherein the one or more heat sources includes a first and second heat source mounted at opposing locations on the top plate such that the first and second heat sources are oriented towards different portions of the envelope material.

3. The aerial vehicle of claim 1, wherein the one or more heat sources are arranged to create the one or more openings between tendons of the envelope such that the tendons remain intact when the envelope material is melted.

4. The aerial vehicle of claim 1, further comprising a drag device arranged at the top plate, the drag device being configured to provide stability to the envelope during descent.

5. The aerial vehicle of claim 4, wherein the drag device includes a pair of drag elements each including a plurality of supports with material arranged between ones of the plurality of supports.

6. The aerial vehicle of claim 5, wherein the one or more heat sources are arranged to create the openings between edges of the drag elements of the pair of drag elements in order to reduce a likelihood of damage to the pair of drag elements when the fluid melts the envelope material.

7. The aerial vehicle of claim 5, wherein the material arranged between the supports is a same material as the envelope material.

8. The aerial vehicle of claim 1, wherein each gas generator further includes a safety interlock having a pressure switch configured to prevent activation of an initiator of that gas generator below a predetermined altitude.

9. The aerial vehicle of claim 1, further comprising:
a payload;
a separation apparatus including a squib configured to separate the payload from the envelope; and
a control system including a pressure sensor, the control system being configured to cause the squib to activate the separation apparatus and separate the payload from the envelope based on feedback from the pressure sensor.

10. The aerial vehicle of claim 9, wherein the control system is further configured to receive a pressure for separation and cause the squib to activate the separation apparatus when the feedback indicates that the aerial vehicle has reached the pressure for separation.

11. The aerial vehicle of claim 9, further comprising a parachute for the payload, and wherein the control system is further configured to receive a pressure for deployment and cause the parachute for the payload to deploy when the feedback indicates that the payload has reached the pressure for deployment.

12. The aerial vehicle of claim 11, further comprising a parachute for the envelope, and wherein the parachute is configured to deploy upon activation of the separation apparatus and the parachute for the payload is configured to deploy at some point in time after deployment of the parachute for the envelope.

13. The aerial vehicle of claim 12, wherein the control system is configured to cause the parachute for the payload to deploy at a lower altitude than the parachute for the envelope is deployed.

14. The aerial vehicle of claim 12, wherein the parachute for the envelope and the parachute for the payload are configured such that the parachute for the envelope is configured to create a lower amount of drag than the parachute for the payload.

15. The aerial vehicle of claim 12, wherein the pressure for deployment allows for the payload and the envelope to maintain a minimum separation distance between the payload and the envelope after separation and while both the payload and the envelope are descending.

16. An aerial vehicle management system comprising one or more computing devices having one or more processors, the one or more computing devices being configured to:
determine that flight of an aerial vehicle should be terminated;
determine a landing area for the aerial vehicle;
determine a ground level of the landing area;
based on the determined ground level, determine a pressure for separation that corresponds to an altitude at least a predetermined height above the ground level;
determine a pressure for deployment of a parachute for the aerial vehicle based on the determined ground level, wherein the pressure for deployment corresponds to an altitude that is lower than the pressure for separation; and
send the pressure for separation and the pressure for deployment to the aerial vehicle in order to cause the aerial vehicle to terminate the flight using the pressure for separation and the pressure for deployment.

17. The system of claim 16, wherein the pressure for deployment corresponds to an altitude that is lower than the pressure for separation.

18. The system of claim 16, wherein the predetermined height is at least 10,000 feet above ground level.

19. The system of claim 16, wherein the predetermined height is no more than 10,000 feet above ground level.

20. The system of claim 16, further comprising the aerial vehicle.
